(19) United States
(12) Patent Application Publication
(10) Pub. No.: US 2008/0052671 A1
(43) Pub. Date: Feb. 28, 2008

(54) SYSTEM, METHOD AND PROGRAM PRODUCT FOR PROVIDING CONTENT BASED DESIGNATIONS FOR PROGRAMMING OBJECTS

(76) Inventors: Frederic Plante, Chelsea (CA); Daniel D. J. Leroux, Kanata (CA); Lawrence S. Rich, Cary, NC (US)

Correspondence Address: HOFFMAN WARNICK & DALESSANDRO LLC, 75 STATE ST, 14TH FLOOR, ALBANY, NY, 12207, US

(21) Appl. No.: 11/462,249

(22) Filed: Aug. 3, 2006

(51) Int. Cl. G06F 9/44

(52) U.S. Cl. 717/114

(57) ABSTRACT

A way to define an access control that scales to component architectures. Specifically, the present invention allows annotations to be added to objects, for example in the javadoc section of a Java object, to restrict access to that object. Each annotation comprises a tag that specifies a designated privilege and one or more designees to which the privilege applies. The annotations may designate access options such as which packages, classes, interfaces, fields and/or operations may be visible to another package, class, interface, field and/or operation; which classes are allowed to implement a particular interface; which classes are allowed to instantiate a particular class; and/or which classes/interfaces are allowed to extend a particular class/interface. The annotation may refer to allowed objects directly, may refer to a group of classes having similar names, and/or may use an alias, which refers to an external object designation.

### FIELD OF THE INVENTION

The present invention generally relates to computer programming object development and usage. Specifically, the present invention provides tools for providing designations for programming objects that are content based.

### BACKGROUND OF THE INVENTION

The world of information technology is a dynamic and rapidly changing world. As this world of information technology evolves, object oriented programming has come to the forefront as a programming method. As opposed to traditional programming, in which a program is seen as a collection of functions or list of instructions to the computer, in object oriented programming the computer program is seen as a collection of individual units, or objects, which act upon one another by sending messages, processing data, etc. As such, each object or set of objects may be seen as an individual machine that is adapted for performing a distinct responsibility.

One determination that must be made when developing and/or using objects and/or sets of objects in an object oriented environment deals with which objects and/or sets of objects have access to other objects and/or sets of objects. For example, an object, such as a class, may be designed to be visible by members of one class, but not another. Similarly, an interface may be designed such that one particular class should be allowed to implement it, but not another. Still further, a particular class or package of classes may be designed to be instantiated by one class, but not another. Yet still further, a class/interface may be designed to be able to be extended by one class/interface, but not another.

Current tools, if they exist, for regulating access to an object are program based. These program based tools often limit the choices that the user has to designate which objects have access and which do not. For example, a language may limit the accessibility options to:

a “private” member that can only be used within its defining class;

a “package” member that can be accessed by any class within the same package;

a “protected” member that can only be used within its defining class and its sub-classes; and

a “public” member that can be accessed by any class.

However, limited options such as the above do not allow a developer to, for example, designate access to one class that is external to the package while restricting access to another class that is external to the package. Furthermore, even in languages that may allow more flexibility in designating access, the language based approach itself suffers limitations when scaled to large component-based systems because the approach cannot distinguish between designations inside and outside of the component.

In view of the foregoing, there exists a need for a solution that overcomes the shortcomings of the prior art.

### SUMMARY OF THE INVENTION

In general, the present invention provides a way to define an access control that scales to component architectures. Specifically, the present invention allows annotations to be added to objects, for example in the javadoc section of a Java object, to restrict access to that object. Java and all Java-based trademarks are trademarks of Sun Microsystems, Inc. in the United States, other countries, or both. Each annotation comprises a tag that specifies a designated privilege and one or more designees to which the privilege applies. The annotations may designate access options such as which packages, classes, interfaces, fields and/or operations may be visible to another package, class, interface, field and/or operation; which classes are allowed to implement a particular interface; which classes are allowed to instantiate a particular class; and/or which classes/interfaces are allowed to extend a particular class/interface. The annotation may refer to allowed objects directly, may refer to a group of classes having similar names, and/or may use an alias, which refers to an external object designation.

A first aspect of the present invention provides a method for providing content based designations for programming objects, comprising: obtaining a programming object; and incorporating an annotation into the programming object, wherein the annotation comprises a tag that specifies a designated privilege and a designee to which the privilege applies.

A second aspect of the present invention provides a system for providing content based designations for programming objects, comprising: a programming object obtainer for obtaining a programming object; and an annotation incorporator for incorporating an annotation into the programming object, wherein the annotation comprises a tag that specifies a designated privilege and a designee to which the privilege applies.

A third aspect of the present invention provides a program product stored on a computer readable medium for providing content based designations for programming objects, the computer readable medium comprising: program code for obtaining a programming object; and program code for incorporating an annotation into the programming object, wherein the annotation comprises a tag that specifies a designated privilege and a designee to which the privilege applies.

A fourth aspect of the present invention provides a method for deploying an application for providing content based designations for programming objects, comprising: providing a computer infrastructure being operable to: obtain a programming object; and incorporate an annotation into the programming object, wherein the annotation comprises a tag that specifies a designated privilege and a designee to which the privilege applies.

A fifth aspect of the present invention provides computer software embodied in a propagated signal for providing content based designations for programming objects, the computer software comprising instructions for causing a computer system to perform the following: obtain a programming object; and incorporate an annotation into the programming object, wherein the annotation comprises a tag that specifies a designated privilege and a designee to which the privilege applies.

A sixth aspect of the present invention provides a method for providing content based designations for programming objects, the method comprising managing a computer infrastructure that performs the process described herein; and receiving payment based on the managing.

Therefore, the present invention provides a method, system, and program product for providing content based designations for programming objects.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative computer system for providing content based designations for programming objects according to the present invention.

FIG. 2 shows an annotation incorporator under one embodiment of the present invention.

FIG. 3 shows the function of an access control annotator according to one embodiment of the present invention.

FIG. 4 shows the function of an implementation annotator according to one embodiment of the present invention.

FIG. 5 shows the function of an instantiation annotator according to one embodiment of the present invention.

FIG. 6 shows the function of an extending annotator according to one embodiment of the present invention.

FIG. 7 shows an illustrative method flow diagram according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the present invention provides a way to define an access control that scales to component architectures. Specifically, the present invention allows annotations to be added to objects, for example in the javadoc section of a Java object, to restrict access to that object. Each annotation comprises a tag that specifies a designated privilege and one or more designees to which the privilege applies. The annotations may designate access options such as which packages, classes, interfaces, fields and/or operations may be visible to another package, class, interface, field and/or operation; which classes are allowed to implement a particular interface; which classes are allowed to instantiate a particular class; and/or which classes/interfaces are allowed to extend a particular class/interface. The annotation may refer to allowed objects directly, may refer to a group of classes having similar names, and/or may use an alias, which refers to an external object designation.

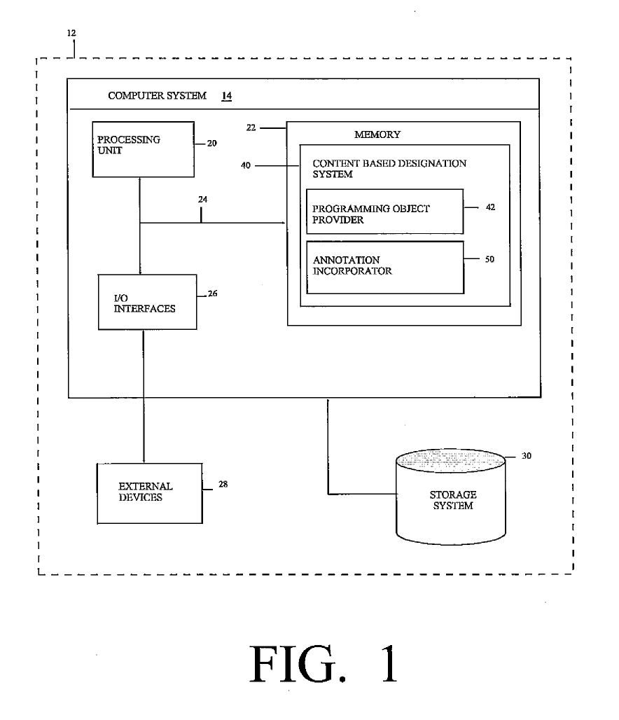

Referring now to FIG. 1, a system 10 for providing content based designations for programming objects according to the present invention is shown. Specifically, FIG. 1 depicts a system 10 in which access to objects may be more effectively designated. As depicted, system 10 includes a computer system 14 deployed within a computer infrastructure 12. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by a conventional TCP/IP sockets-based protocol, and an Internet service provider could be used to establish connectivity to the Internet. Still yet, computer infrastructure 12 is intended to demonstrate that some or all of the components of system 10 could be deployed, managed, serviced, etc. by a service provider who offers to configure a data source in a first format for use in an environment requiring a second format.

As shown, computer system 14 includes a processing unit 20, a memory 22, a bus 24, and input/output (I/O) interfaces 26. Further, computer system 14 is shown in communication with external I/O devices/resources 28 and storage system 30. In general, processing unit 20 executes computer program code, such as a content based designation system 40, which is stored in memory 22 and/or storage system 30. While executing computer program code, processing unit 20 can read and/or write data to/from memory 22, storage system 30, and/or I/O interfaces 26. Bus 24 provides a communication link between each of the components in computer system 14. External devices 28 can comprise any devices (e.g., keyboard, pointing device, display, etc.) that enable a user to interact with computer system 14 and/or any devices (e.g., network card, modem, etc.) that enable computer system 14 to communicate with one or more other computing devices.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the various process steps of the invention. Moreover, computer system 14 is only representative of various possible computer systems that can include numerous combinations of hardware and/or software. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interfaces 26 can comprise any system for exchanging information with one or more external devices 28. Still further, it is understood that one or more additional components (e.g., system software, math co-processing unit, etc.) not shown in FIG. 1 can be included in computer system 14. However, if computer system 14 comprises a handheld device or the like, it is understood that one or more external devices 28 (e.g., a display) and/or storage system(s) 30 could be contained within computer system 14, not externally as shown.

Storage system 30 can be any type of system (e.g., a database) capable of providing storage for information under the present invention. For example, storage system 30 may be used to store one or more programming objects used by the present invention, such as a class, a package, and/or an interface. To this extent, storage system 30 could include one or more storage devices, such as a magnetic disk drive or an optical disk drive. In another embodiment, storage system 30 includes data distributed across, for example, a local area network (LAN), wide area network (WAN) or a storage area network (SAN) (not shown). Although not shown, additional components, such as cache memory, communication systems, system software, etc., may be incorporated into computer system 14.

Shown in memory 22 of computer system 14 is content based designation system 40, which is a software program that provides the functions of the present invention. Content based designation system 40 provides a system for providing content based designations for programming objects. To this extent, content based designation system 40 includes a programming object obtainer 42 and an annotation incorporator 50.

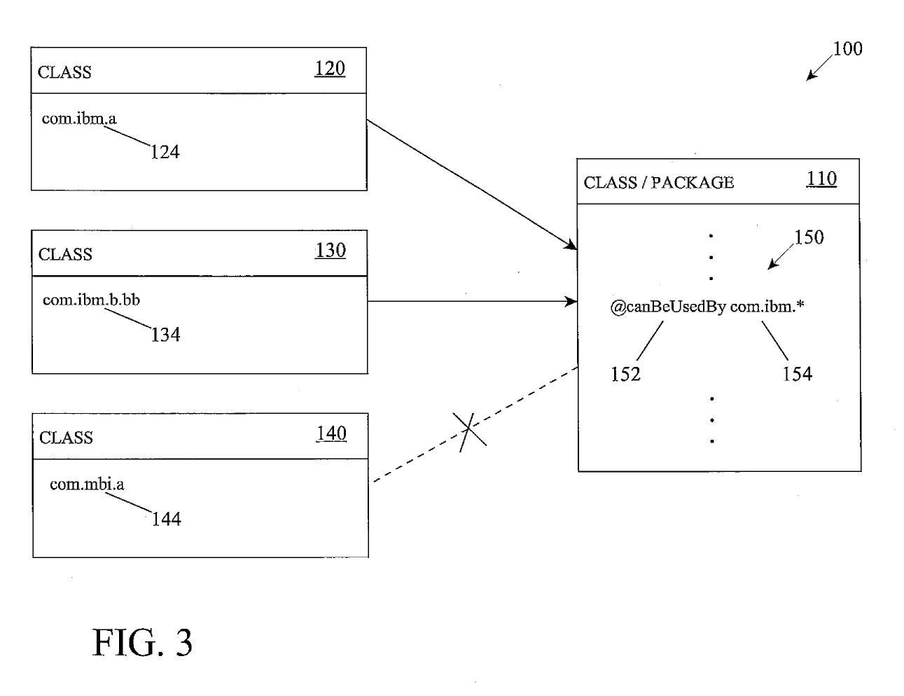

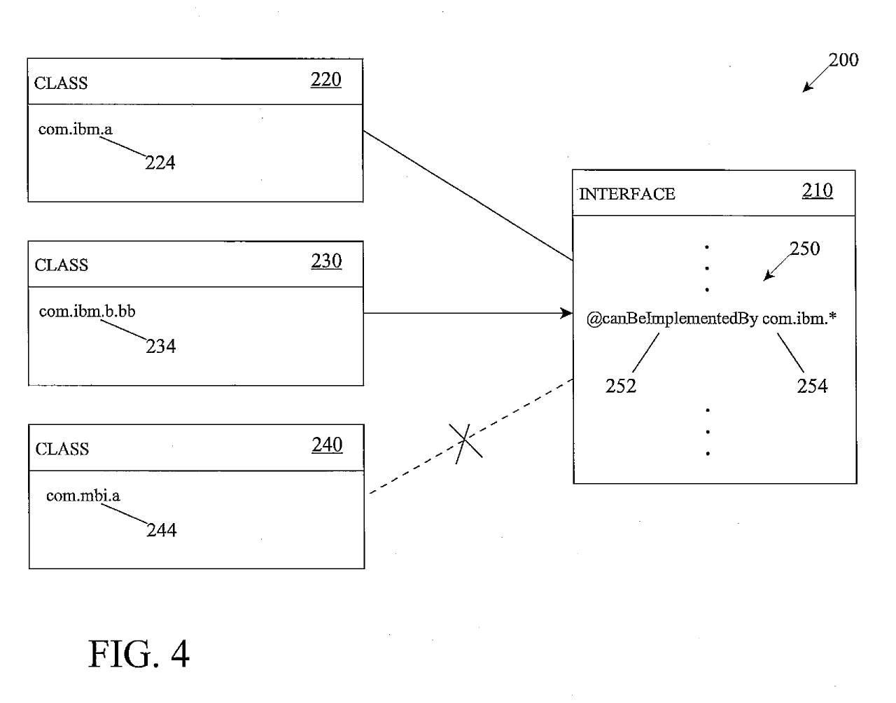

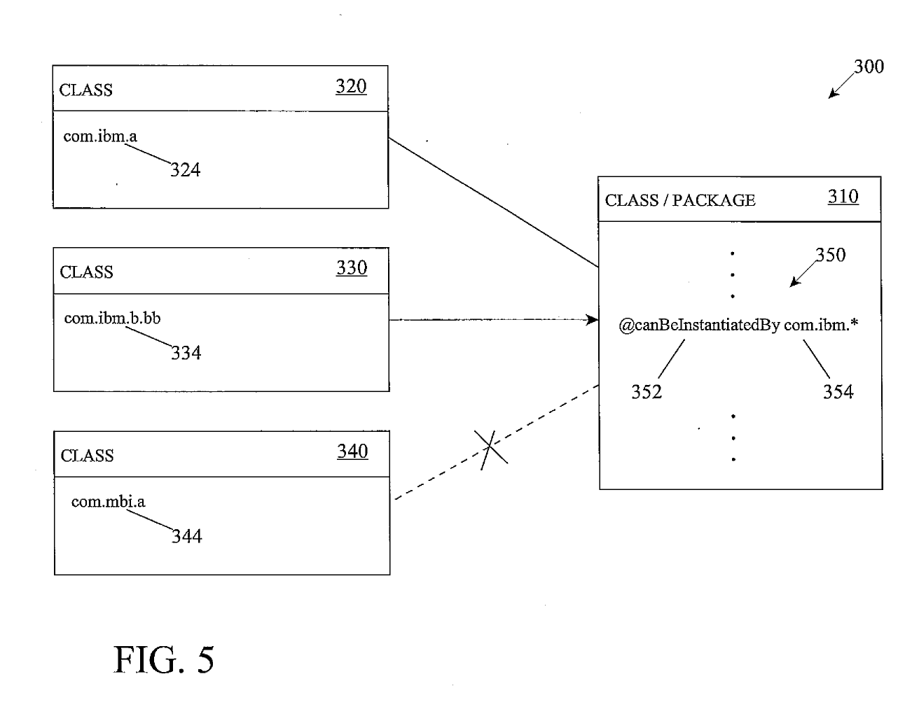

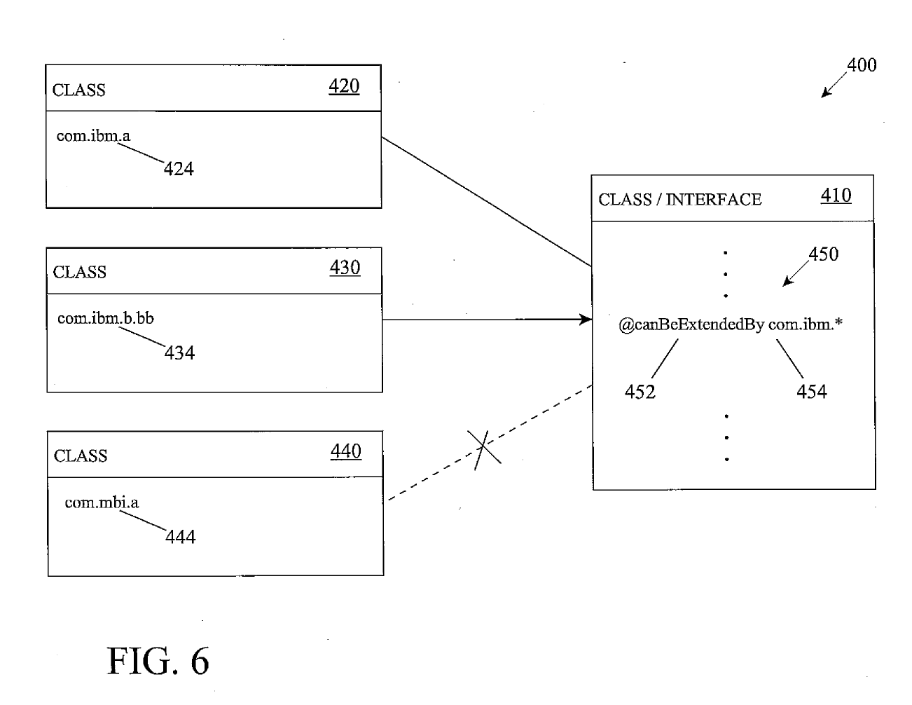

Referring now to FIG. 1 in conjunction with FIGS. 3-6, programming object obtainer 42 of content based designation system 40 obtains a programming object 110, 210, 310, 410 to which the content based designation is to be applied. The obtained programming object 110, 210, 310, 410 may be a package as in FIGS. 3 and 5, a class as in FIGS. 3, 5 and 6, an interface as in FIGS. 4 and 6, a field, an operation or any other object that may be used in object oriented programming. The obtained programming object 110, 210, 310, 410 may be in one of a variety of programming language formats, including, but not limited to Java, C++, smalltalk, SIMULA, Ruby, Python, Delphi, and VB .NET. Programming object obtainer 42 may include a data input apparatus for allowing a user to input the data comprising programming object 110, 210, 310, 410. In the alternative, programming object 110, 210, 310, 410 may be retrieved from an external source, such as storage system 30.

Annotation incorporator 50 of content based designation system 40 incorporates at least one annotation 150, 250, 350, 450 into programming object 110, 210, 310, 410 obtained by programming object obtainer 42. Annotation 150, 250, 350, 450 comprises a tag 152, 252, 352, 452 that specifies a designated privilege and a designee 154, 254, 354, 454 to which the privilege applies. Annotation 150, 250, 350, 450 may be incorporated into the javadoc section of programming object 110, 210, 310, 410 if it is a Java object. Alternatively, in the case of a non-Java programming object 110, 210, 310, 410, annotation 150, 250, 350, 450 may be incorporated according to conventions corresponding to the particular programming language in which the object is written. To this end, tag 152, 252, 352, 452 may be indicated in an @<tag> format as illustrated or in any manner that is customary in the programming language being used.

As indicated, designee 154, 254, 354, 454 of annotation 150, 250, 350, 450 indicates to whom the privilege designated by tag 152, 252, 352, 452 applies. To this end, designee 154, 254, 354, 454 may include a single entry as indicated in FIGS. 3-6 or, in the alternative, may include several entries in sequence. Furthermore, one or more entries of designee 154, 254, 354, 454 may include a “wildcard” such as the character “*” to indicate that any object that has the specified characters is acceptable. Still further, designee may include an alias name that refers to an alternate destination for the entries.

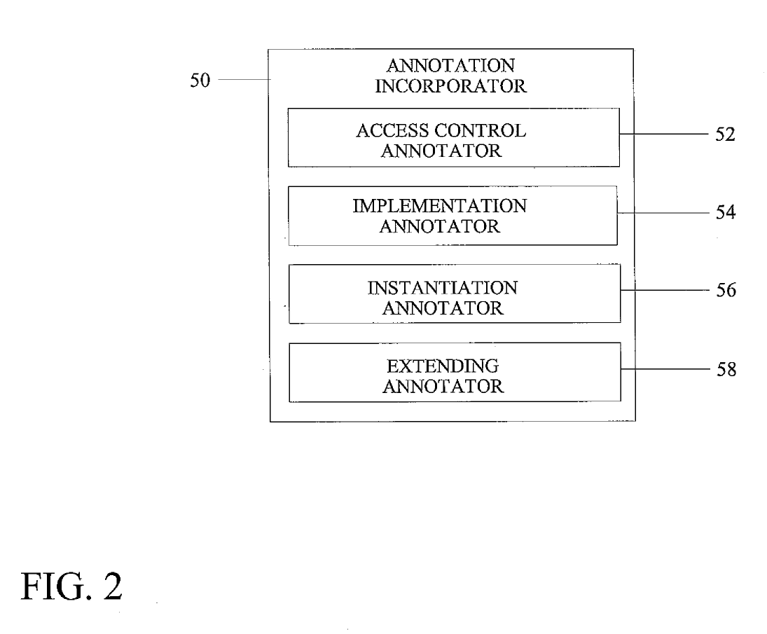

Referring now to FIG. 2 a more detailed embodiment of annotation incorporator 50 is illustrated. As shown, annotation incorporator 50 includes access control annotator 52, implementation annotator 54, instantiation annotation 56, and extending annotator 58. Annotation incorporator 50 may use one or more of the above in incorporating annotation 150, 250, 350, 450 into programming object 110, 210, 310, 410.

Referring now to FIGS. 2 and 3 concurrently, access control annotator 52 of annotation incorporator 50 incorporates a designated privilege into programming object 110 that includes a designation of which class or classes are allowed to access programming object 110 of type class or package. As shown in FIG. 3, access control annotator 52 has incorporated annotation 150 into programming object 110. Annotation 150 has tag 152 of @canBeUsedBy, indicating that designee 154 can access programming object 110. Designee 154 has an entry of com.ibm.*, indicating that any class that has a name that begins with com.ibm is given the designated privilege, in this case, for access. To this extent, in the example scenario 100, both classes com.ibm.a and com.ibm.b.bb would be allowed to access programming object 110 while class com.mbi.a would not. This is true regardless of whether or not any or all of classes com.ibm.a, com.ibm.b.bb and com.mbi.a were in the same or different class, sub-class, and/or package.

Referring now to FIGS. 2 and 4 concurrently, implementation annotator 54 of annotation incorporator 50 incorporates a designated privilege into programming object 210 that includes a designation of which class or classes are allowed to implement programming object 210 of type interface. As shown in FIG. 4, implementation annotator 54 has incorporated annotation 250 into programming object 210. Annotation 250 has tag 252 of @canBelmplementedBy, indicating that designee 254 can implement programming object 210. Designee 254 has an entry of com.ibm.*, indicating that any class that has a name that begins with com.ibm is given the designated privilege, in this case, to implement the interface. To this extent, in the example scenario 200, both classes com.ibm.a and com.ibm.b.bb would be allowed to access programming object 210 while class com.mbi.a would not. This is true regardless of whether or not any or all of classes com.ibm.a, com.ibm.b.bb and com.mbi.a were in the same or different class, sub-class, and/or package.

Referring now to FIGS. 2 and 5 concurrently, instantiation annotator 56 of annotation incorporator 50 incorporates a designated privilege into programming object 310 that includes a designation of which class or classes are allowed to instantiate programming object 310 of type class or package. As shown in FIG. 5, instantiation annotator 56 has incorporated annotation 350 into programming object 310. Annotation 350 has tag 352 of @canBeInstantiatedBy, indicating that designee 354 can instantiate programming object 310. Designee 354 has an entry of com.ibm.*, indicating that any class that has a name that begins with com.ibm is given the designated privilege, in this case, for instantiation. To this extent, in the example scenario 300, both classes com.ibm.a and com.ibm.b.bb would be allowed to access programming object 310 while class com.mbi.a would not. This is true regardless of whether or not any or all of classes com.ibm.a, com.ibm.b.bb or com.mbi.a were in the same or different class, sub-class, and/or package.

Referring now to FIGS. 2 and 6 concurrently, extending annotator 58 of annotation incorporator 50 incorporates a designated privilege into programming object 410 that includes a designation of which class or classes are allowed to programming object 410 of type class or interface. As shown in FIG. 6, extending annotator 58 has incorporated annotation 450 into programming object 410. Annotation 450 has tag 452 of @canBeExtendedBy, indicating that designee 454 can extend programming object 410. Designee 454 has an entry of com.ibm.*, indicating that any class that has a name that begins with com.ibm is given the designated privilege, in this case, for instantiation. To this extent, in the example scenario 400, both classes com.ibm.a and com.ibm.b.bb would be allowed to access programming object 410 while class com.mbi.a would not. This is true regardless of whether or not any or all of classes com.ibm.a, com.ibm.b.bb or com.mbi.a were in the same or different class, sub-class, and/or package.

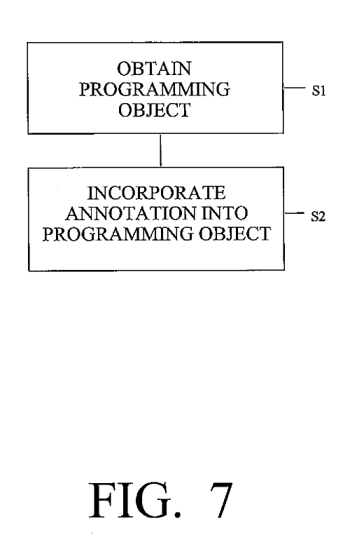

Turning now to FIG. 7, a flow chart of a method according to an embodiment of the present invention is depicted, which is described with reference to FIG. 1. In step S1, programming object obtainer 42 obtains a programming object. Programming object may be any type of object used in object oriented programming and may be obtained by creating it anew or retrieving it from storage. In step S2, annotation incorporator 50 incorporates an annotation into the programming object. Annotation incorporator 50 may utilize access control annotator 52, implementation annotator 54, instantiation annotator 56, and/or extending annotator 58 in incorporation the annotation into the programming object. The annotation that is incorporated into the programming object comprises a tag that specifies a designated privilege and a designee to which the privilege applies and allows for more flexible access control to the programming object.

While shown and described herein as a method and system for providing content based designations for programming objects, it is understood that the invention further provides various alternative embodiments. For example, in one embodiment, the invention provides a computer-readable/useable medium that includes computer program code to enable a computer infrastructure to provide content based designations for programming objects. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 30 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a method that performs the process steps of the invention on a subscription, advertising, and/or fee basis. That is, a service provider, such as a Solution Integrator, could offer a service that provides content based designations for programming objects. In this case, the service provider can create, maintain, support, etc., a computer infrastructure, such as computer infrastructure 12 (FIG. 1) that performs the process steps of the invention for one or more entities. In return, the service provider can receive payment from the entity(s) under a subscription and/or fee agreement and/or the service provider can receive payment from the sale of advertising content to one or more third parties.

In still another embodiment, the invention provides a computer-implemented method for providing content based designations for programming objects. In this case, a computer infrastructure, such as computer infrastructure 12 (FIG. 1), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for providing content based designations for programming objects, comprising:
obtaining a programming object; and
incorporating an annotation into the programming object,
wherein the annotation comprises a tag that specifies a designated privilege and a designee to which the privilege applies.

2. The method of claim 1, wherein the programming object is at least one of a class, a package and an interface.

3. The method of claim 1, wherein the designated privilege includes a designation of a class that is allowed to access the programming object.

4. The method of claim 1, wherein the designated privilege includes a designation of a class that is allowed to implement the programming object and wherein the programming object is an interface.

5. The method of claim 1, wherein the designated privilege includes a designation of a calling class that is allowed to instantiate the programming object and wherein the programming object is at least one of a class and a package.

6. The method of claim 1, wherein the designated privilege includes a designation of at least one of a calling class and a calling interface that is allowed to extend the programming object and wherein the programming object is at least one of a class and an interface.

7. The method of claim 1, wherein annotation includes a plurality of designees.

8. The method of claim 1, wherein the designee is indicated by an alias.

9. A system for providing content based designations for programming objects, comprising:
a programming object obtainer for obtaining a programming object; and
an annotation incorporator for incorporating an annotation into the programming object,
wherein the annotation comprises a tag that specifies a designated privilege and a designee to which the privilege applies.

10. The system of claim 9, wherein the annotation incorporator includes an access control annotator for incorporating the designated privilege that includes a designation of a class that is allowed to access the programming object, wherein the programming object is at least one of a class and a package.

11. The system of claim 9, wherein the annotation incorporator includes an implementation annotator for incorporating the designated privilege that includes a designation of a class that is allowed to implement the programming object and wherein the programming object is an interface.

12. The system of claim 9, wherein the annotation incorporator includes an instantiation annotator for incorporating the designated privilege that includes a designation of a calling class that is allowed to instantiate the programming object and wherein the programming object is at least one of a class and a package.

13. The system of claim 9, wherein the annotation incorporator includes an extending annotator for incorporating the designated privilege that includes a designation of at least one of a calling class and a calling interface that is allowed to extend the programming object and wherein the programming object is at least one of an class and an interface.

14. The system of claim 9, wherein the designee is indicated by an alias.

15. A program product stored on a computer readable medium for providing content based designations for programming objects, the computer readable medium comprising:
program code for obtaining a programming object; and
program code for incorporating an annotation into the programming object,
wherein the annotation comprises a tag that specifies a designated privilege and a designee to which the privilege applies.

16. The program product of claim 15, wherein the designated privilege includes a designation of a class that is allowed to access the programming object and wherein the programming object is at least one of a class and a package.

17. The program product of claim 15, wherein the designated privilege includes a designation of a class that is allowed to implement the programming object and wherein the programming object is an interface.

18. The program product of claim 15, wherein the designated privilege includes a designation of a calling class that is allowed to instantiate the programming object and wherein the programming object is at least one of a class and a package.

19. The program product of claim 15, wherein the designated privilege includes a designation of at least one of a calling class and a calling interface that is allowed to extend the programming object and wherein the programming object is at least one of an class and an interface.

20. A method for deploying an application for providing content based designations for programming objects, comprising:
obtaining a programming object; and
incorporating an annotation into the programming object,
wherein the annotation comprises a tag that specifies a designated privilege and a designee to which the privilege applies.
